(19) United States
(12) Patent Application Publication
(10) Pub. No.: US 2018/0060315 A1
(43) Pub. Date: Mar. 1, 2018

(54) PERFORMING FILE SYSTEM MAINTENANCE

(71) Applicant: INTERNATIONAL BUSINESS MACHINES CORPORATION, Armonk, NY (US)

(72) Inventors: Asmahan A. Ali, Highland, NY (US); Ali Y. Duale, Poughkeepsie, NY (US); Mustafa Y. Mah, Highland, NY (US)

(21) Appl. No.: 15/252,984

(22) Filed: Aug. 31, 2016

(51) Int. Cl. G06F 17/30

(52) U.S. Cl. CPC G06F 17/3007; G06F 17/30144; G06F 17/30138; G06F 17/30371; G06F 17/30598

(57) ABSTRACT

Embodiments include methods, and a file system maintenance manager, and computer program products for performing file system maintenance. Aspects may include: surveying, by a file system maintenance manager, available compute nodes, and determining an amount of file system maintenance work to be performed in an unprocessed work chunk pool. The aspect may include dispatching work chunks to the available compute nodes for performing file system maintenance. The aspect may also include monitoring status changes of the compute nodes, and adjusting the work chunks dispatched to each available compute node according to the status changes of the compute nodes. The aspect may further include detecting capacity and performance of each of compute nodes, classifying the compute nodes available into high speed, medium speed, and low speed categories, and dispatching unprocessed work chunks to each of compute nodes dynamically, according to the capacity and performance of the compute nodes.

### BACKGROUND

The present disclosure relates generally to performing file system maintenance, and more particularly to cognitive methods and systems for performing file system maintenance.

Performing file system maintenance on a large computer system or a large data center having hundreds of compute nodes and thousands of storage devices takes a long time and requires a lot of work to be performed. Some of the examples of work performed include: restriping, defragmentation, and checking the integrity of a file system. Currently, when a file system maintenance process is started, only those compute nodes available to perform file system maintenance at the start may be utilized during the file system maintenance. For example, for a data center having 500 compute nodes, and 1000 storage devices, when there are only 300 compute nodes available at the start, then the other 200 may not be used even if these 200 compute nodes becomes available after the start.

Currently, file system maintenance does not account for processing capacity and performance of each individual compute mode, and when dispatching work chunks, each of the compute nodes receives an equal amount of work chunks, even though some of the compute nodes are high-performance computers and can perform quicker than other compute nodes.

Additionally, when a compute mode fails during the file system maintenance process, there is no tracking where this compute mode stopped, the entire file system maintenance process may have to be aborted and restarted, which wastes a lot of computer resources.

### SUMMARY

In an embodiment of the present invention, a method for performing file system maintenance may include: surveying, by a system status monitor of a file system maintenance manager, one or more compute nodes available, and determining, by a file system maintenance controller, an amount of file system maintenance work to be performed in an unprocessed work chunk pool. The method may include dispatching, by a work chunk dispatcher, work chunks to the compute nodes available for performing file system maintenance. The method may also include monitoring, by the system status monitor, status changes of the compute nodes available, and adjusting, by the by the file system maintenance controller, the work chunks dispatched to each of the compute nodes available according to the status changes of the compute nodes available. The method also includes detecting, by the system status monitor, capacity and performance of each of compute nodes available, and classifying the compute nodes available into high speed, medium speed, and low speed categories, and dispatching, by the work chunk dispatcher, unprocessed work chunks to each of the compute nodes available dynamically, according to the capacity and performance of the compute nodes available.

In another embodiment of the present invention, a file system maintenance manager for performing file system maintenance includes a memory storing computer executable instructions for the file system maintenance manager, and a processor for executing the computer executable instructions. The computer executable instructions includes: a system status monitor configured to survey a plurality of compute nodes available, and monitor status changes of the plurality of compute nodes available, a communication interface configured to enable the file system maintenance manager to communicate with the plurality of compute nodes available over a cloud. The computer executable instructions may also include: a file system maintenance controller configured to determine an amount of file system maintenance work to be performed, and adjust the work chunks dispatched to the compute nodes available according to the status changes of the compute nodes available, and a work chunk dispatcher configured to dispatch the work chunks in the unprocessed work chunk pool to the compute nodes available for performing file system maintenance.

In yet another embodiment of the present invention, the present disclosure relates to a non-transitory computer storage medium. In certain embodiments, the non-transitory computer storage medium stores computer executable instructions. When these computer executable instructions are executed by a processor of a file system maintenance manager, these computer executable instructions cause the processor to survey, using a system status monitor, one or more compute nodes available, and determine, using a file system maintenance controller, an amount of file system maintenance work to be performed in an unprocessed work chunk pool. The computer executable instructions may cause the processor to dispatch, using a work chunk dispatcher, the work chunks to the compute nodes available for performing file system maintenance. The computer executable instructions may also cause the processor to monitor, using the system status monitor, status changes of the compute nodes available, and adjust, using the by the file system maintenance controller, the work chunks dispatched to each of the compute nodes available according to the status changes of the compute nodes available.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram of a computing system implementing the teachings herein according to certain embodiments of the present invention;

FIG. 2 is a block diagram of a computing system for performing file system maintenance according to certain embodiments of the present invention;

FIG. 3 is a block diagram of the file system maintenance manager according to certain embodiments of the present invention; and

FIG. 4 is a flow chart of a method of for performing file system maintenance according to certain embodiments of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “plurality” means two or more. The terms “comprising,” “including,” “carrying,” “having,” “containing,” “involving,” and the like are to be understood to be open-ended, i.e., to mean including but not limited to.

“Restriping” a file system is a maintenance process to re-balance data evenly on storage devices for file systems that stripes data to achieve maximum performance.

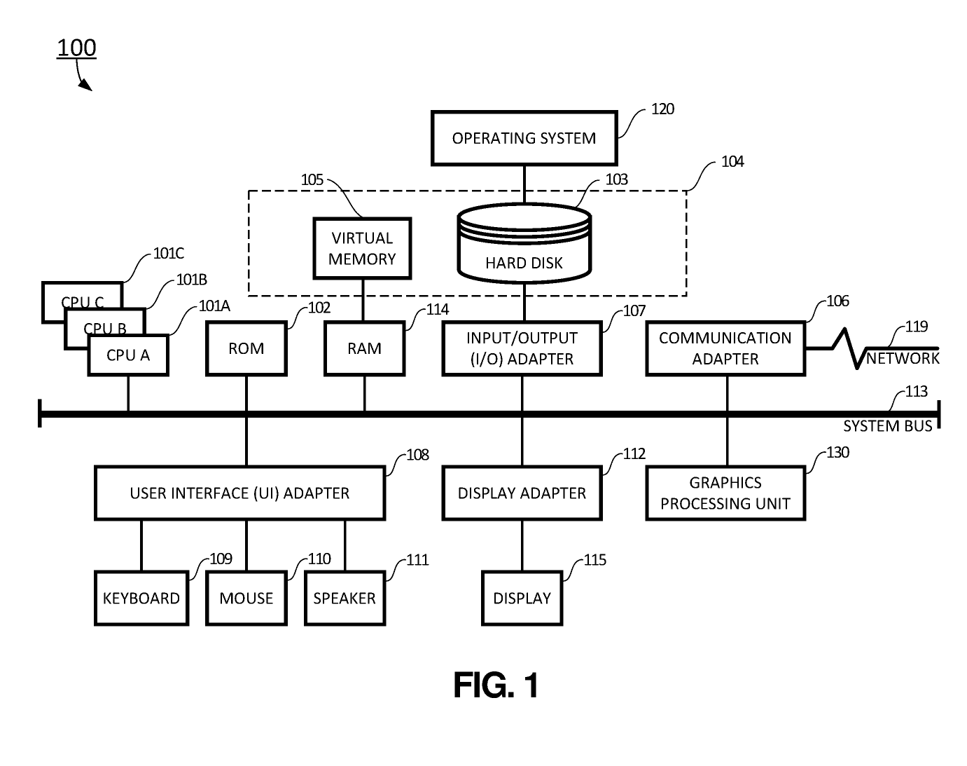

The present disclosure will now be described more fully hereinafter with reference to the accompanying drawings FIGS. 1-4, in which certain exemplary embodiments of the present disclosure are shown. The present disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

Referring to FIG. 1, an embodiment of a computing system 100 for performing file system maintenance and implementing the teachings herein. In this embodiment, the computing system 100 has one or more processors 101A, 101B, 101C, etc. (collectively or generically referred to as processor(s) 101). In one embodiment, each processor 101 may include a reduced instruction set computer (RISC) microprocessor. Processors 101 are coupled to a system memory 114 and various other components via a system bus 113. Read only memory (ROM) 102 is coupled to the system bus 113 and may include a basic input/output system (BIOS), which controls certain basic functions of the computing system 100.

FIG. 1 further depicts an input/output (I/O) adapter 107 and a communication adapter 106 coupled to the system bus 113. I/O adapter 107 may be a small computer system interface (SCSI) adapter that communicates with a hard disk 103 and/or virtual memory 105 or any other similar component. I/O adapter 107, hard disk 103, and the virtual memory device 105 are collectively referred to herein as mass storage 104. An operating system 120 for execution on the computing system 100 may be stored in mass storage 104. The communication adapter 106 interconnects bus 113 with an outside network 116 enabling the computing system 100 to communicate with other such systems. A screen (e.g., a display monitor) 115 is connected to system bus 113 by a display adaptor 112, which may include a graphics adapter to improve the performance of graphics intensive applications and a video controller. In one embodiment, the I/O adapters 107, the communication adapter 106, and the display adapter 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and the display adapter 112. A keyboard 109, a mouse 110, and one or more speakers 111 all interconnected to bus 113 via user interface adapter 108, which may include, for example, a Super I/O chip integrating multiple device adapters into a single integrated circuit.

In exemplary embodiments, the computing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 1, the computing system 100 includes processing capability in the form of processors 101, storage capability including the system memory 114 and mass storage 104, input means such as the keyboard 109 and the mouse 110, and the output capability including the one or more speakers 111 and display 115. In one embodiment, a portion of the system memory 114 and mass storage 104 collectively store the operating system 120 to coordinate the functions of the various components shown in FIG. 1. In certain embodiments, the network 116 may include symmetric multiprocessing (SMP) bus, a Peripheral Component Interconnect (PCI) bus, local area network (LAN), wide area network (WAN), telecommunication network, wireless communication network, and the Internet.

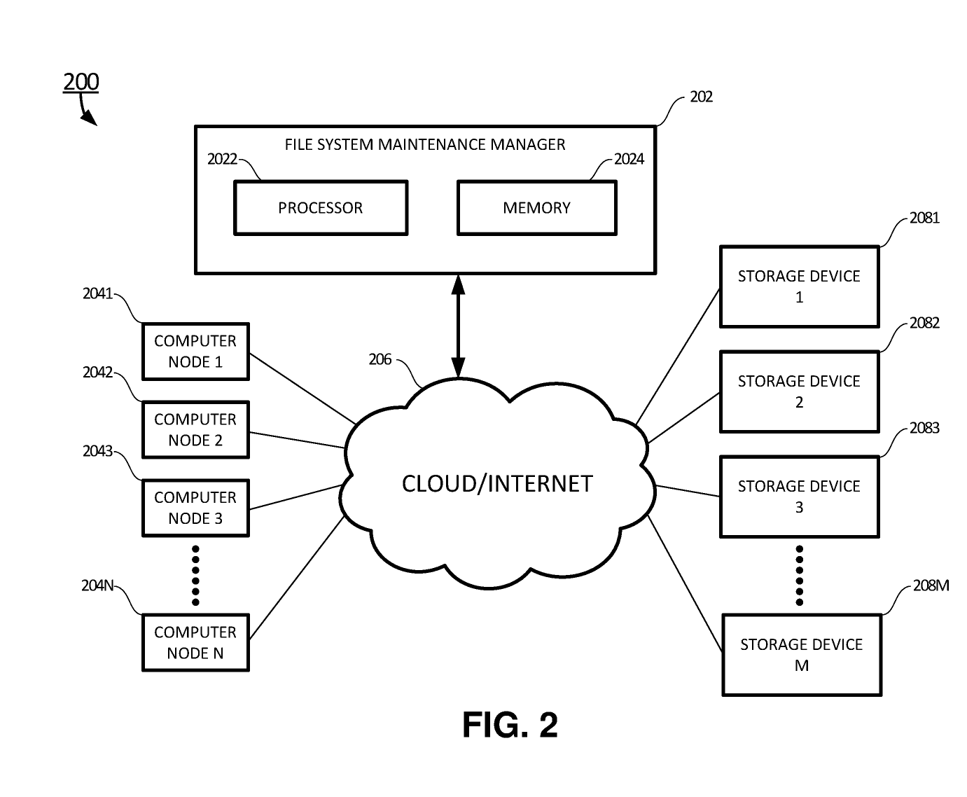

In one aspect, the present disclosure relates to a file system maintenance manager 202 for performing file system maintenance as shown in FIG. 2, according to certain embodiments of the present disclosure. The file system maintenance manager 202 includes a memory 2024 that stores computer executable instructions for the file system maintenance manager 202, and a processor 2022 for executing the computer executable instructions. The file system maintenance manager 202 is configured to perform file system maintenance on a file system. The file system includes N compute nodes, compute mode 1 (2041), compute mode 2 (2042), compute mode 3 (2043), . . . , and compute mode N (204N), where N is a positive integer, and M storage devices, storage device 1 (2081), storage device 2 (2082), storage device 3 (2083), . . . , and storage device M (208M), where M is another positive integer. These N compute nodes and M storage devices are connected to the file system maintenance manager 202 through a cloud/internet 206.

In certain embodiments, the file system maintenance includes restriping a file system to fully utilize all compute nodes available and all storage devices available and performing defragmentation on each of the storage devices available to increase the processing speed of the storage devices available. The file system maintenance also includes changing working status of the compute nodes available at starts and stops, changing working status of the storage devices available at starts and stops, optimizing the file system by fully utilizing the compute nodes available, and balancing work loads on each of the compute nodes available, and balancing file storage on each of storage devices available.

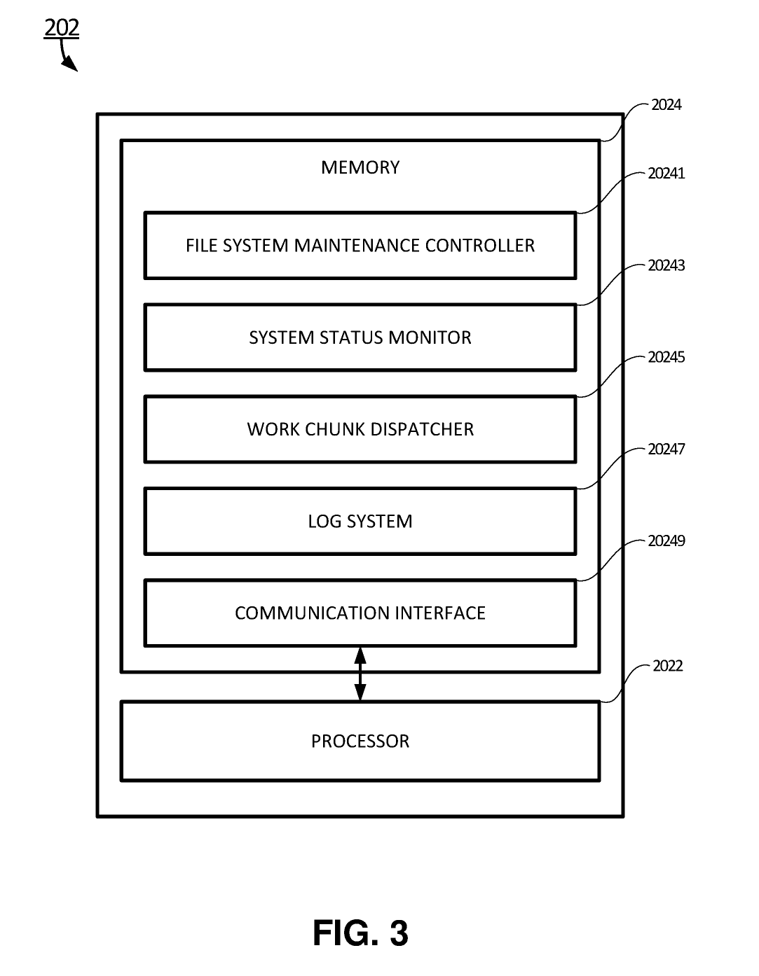

In certain embodiments, the computer executable instructions stored in the memory 2024 include a file system maintenance controller 20241, a system status monitor 20243, a work chunk dispatcher 20245, and a communication interface 20249, as shown in FIG. 3.

The file system maintenance controller 20241 is configured to determine an amount of file system maintenance work to be performed. The amount of file system maintenance work determined is divided into multiple work chunks and the work chunks are placed in an unprocessed work chunk pool. In one embodiment, the amount of file system maintenance work determined is divided into equal sized work chunks. The file system maintenance controller 20241 is also configured to adjust the work chunks dispatched to each of the compute nodes available according to the status changes of the compute nodes available.

For example, when one or more compute nodes become available, the file system maintenance controller 20241 may dispatch some unprocessed work chunks to these compute nodes. When one or more compute nodes become unavailable, the file system maintenance controller 20241 may check a log file corresponding to the compute mode that becomes unavailable in a log system 20247 to determine any unprocessed work chunks and return these unprocessed work chunks to the unprocessed work chunk pool.

In certain embodiments, the system status monitor 20243 surveys the file system and determines one or more compute nodes available and one or more storage devices available for file system maintenance process. The system status monitor 20243 also monitors status changes of the compute nodes available and the storage devices available determined. In certain embodiments, the file system maintenance manager 202 continuously monitors the status changes of the compute nodes available and the storage devices available in a predetermined interval using the system status monitor 20243. The status changes may include one or more compute nodes become available, one or more compute nodes become unavailable, one or more storage devices become available, and one or more storage devices become unavailable. A storage device becomes unavailable when a file system daemon is terminated on a corresponding compute mode performing the file system maintenance on the storage device.

In certain embodiments, for example, a file system includes three storage devices, storage device 1, storage device 2, and storage device 3. The storage device 1 stores a Data Chunk 1, storage device 2 stores a Data Chunk 2, and storage device 3 stores s Data Chunk 3. When certain maintenance work is to be performed on the storage device 2, the Data Chunk 2 on the storage device 2 is moved to a different storage location, for example, the storage device 3 and the storage device 2 may be brought down. Then the data are stored in an unbalanced way, the storage device 1 stores a Data Chunk 1, the storage device 2 stores nothing, and the storage device 3 stores the Data Chunk 2 and the Data Chunk 3. Once the file system maintenance on the storage device 2 is completed, the storage device 2 may be brought back online, or made available. The file system maintenance controller 20241 may dispatch/move the Data Chunk 2 on the storage device 3 to storage device 2 to make the file storage more balanced.

In certain embodiments, the file system maintenance manager 202 may detect processing capacity and performance of each of the compute nodes available, and classifying the compute nodes available into high speed, medium speed, and low-speed categories, by the system status monitor 20243.

In exemplary embodiments, the system status monitor 20243 can also detect processing capacity and performance of each of the compute nodes available, and classifying the compute nodes available into categories such as high speed, medium speed, and low speed. This capability allows the file system maintenance manager 202 to dynamically allocate appropriate resource to perform file system maintenance according to the processing capacity and performance of each of the compute nodes and balance the work load based on the compute nodes capacity. The system status monitor 20243 can determine the capacity of each computer system and then dispatch unprocessed work chunks from the unprocessed work chunk pool to each of the compute nodes available dynamically by the work chunk dispatcher 20245 according to the capacity and performance of each of the compute nodes available intelligently to increase the speed of the file system maintenance process. Give larger work chunks to fast compute nodes so that the file system maintenance process may finish faster.

The communication interface 20249 enables the file system maintenance manager 202 to communicate with the compute nodes available and the storage devices available over the cloud/internet 206.

The work chunk dispatcher 20245 dispatches the work chunks in the unprocessed work chunk pool to the compute nodes available for performing file system maintenance, according to the processing capacity, performance and current working status of each of the compute nodes available.

Traditionally, when one or more compute nodes die during the file system maintenance process, the file system maintenance has to abort the entire file system maintenance process and start over again because the there is no tracking of the working progress of each of the compute nodes. In certain embodiments, the file system maintenance manager 202 includes a log system 20247. When the file system maintenance process starts, a log file is created in the log system 20247 for each of the compute nodes available. This log file receives detailed progress of the file system maintenance for the corresponding compute mode. Therefore, if the compute mode goes down or offline, the file system maintenance manager 202 may check the corresponding log file in the log system 20247 to see where exactly the compute mode failed, and determine what work chunks are processed and what work chunks are still unprocessed such that file system maintenance process does not have to be aborted and restarted. The file system maintenance manager 202 may put the unprocessed work chunks back to the unprocessed work chunk pool, and dispatch the works chunks to other compute nodes available by the work chunk dispatcher 20245.

In another aspect, the present disclosure relates to a method for performing file system maintenance. In certain embodiments, the method includes surveying one or more compute nodes available and one or more storage devices available by using a system status monitor 20243 of a file system maintenance manager 202. The compute nodes available and the storage devices available are in communication with the file system maintenance manager 202 over a cloud 206 through a communication interface 20249. The method also includes determining amount of file system maintenance work to be performed divided into multiple work chunks and placed the unprocessed work chunk pool by using a file system maintenance controller 20241 of the file system maintenance manager 202, and dispatching the work chunks to the compute nodes available for performing file system maintenance by using a work chunk dispatcher 20245 of the file system maintenance manager 202. The method may also include monitoring status changes of the compute nodes available and the storage devices available, by the system status monitor 20243 of the file system maintenance manager 202, and adjusting the work chunks dispatched to each of the compute nodes available according to the status changes of the compute nodes available and the storage devices available by the file system maintenance controller 20241.

In exemplary embodiments, the method also includes monitoring the status changes of the compute nodes availability and the storage devices availability in a predetermined interval. The status changes include one or more compute nodes become available, one or more compute nodes become unavailable, one or more storage devices become available, and one or more storage devices become unavailable. A storage device becomes unavailable when a file system daemon is terminated on a corresponding compute mode performing the file system maintenance on the storage device.

In certain embodiments, the method further includes determining amount of work chunks processed by a compute mode that becomes unavailable by checking on a corresponding log file of a log system 20247, and returning unprocessed work chunks dispatched to the compute mode to the unprocessed work chunk pool for each of the compute nodes that become unavailable. The method may also include dispatching unprocessed work chunks from the unprocessed work chunk pool to each of the compute nodes that become available by the work chunk dispatcher 20245.

In certain embodiments, the method also includes detecting capacity and performance of each of the compute nodes available, and classifying the compute nodes available into high speed, medium speed, and low speed categories, by the system status monitor 20243, and dispatching unprocessed work chunks from the unprocessed work chunk pool to each of the compute nodes available dynamically by the work chunk dispatcher 20245 according to the capacity and performance of each of the compute nodes available.

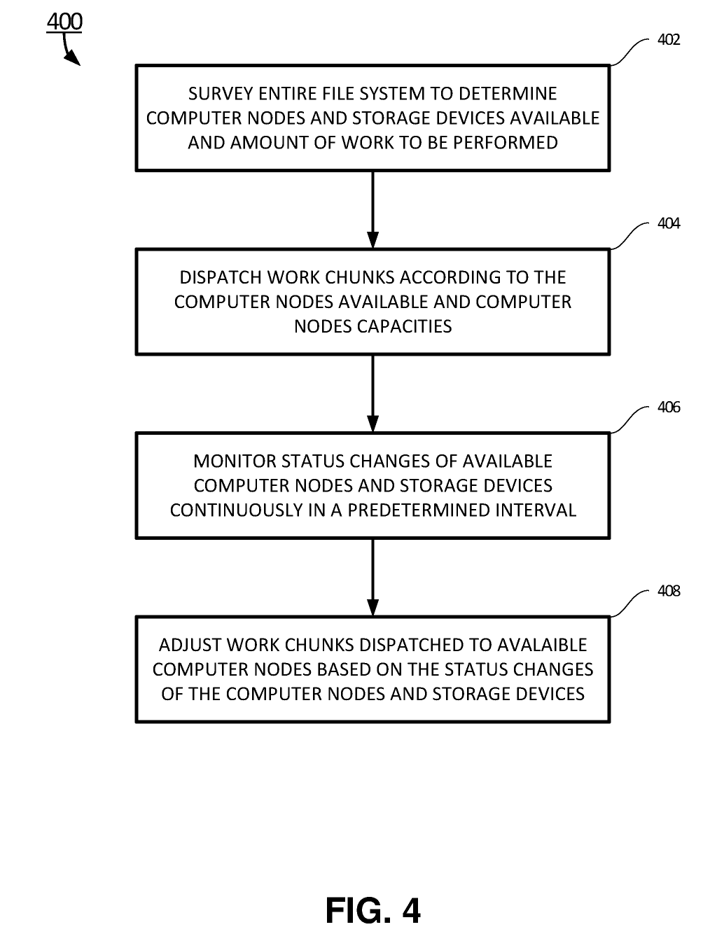

Referring now to FIG. 4, a flow chart of a method 400 for performing file system maintenance is shown according to certain embodiments of the present invention. At the beginning block 402, a system status monitor 20243 of a file system maintenance manager 202 surveys one or more compute nodes available and one or more storage devices available. These compute nodes available and storage devices available are in communication with the file system maintenance manager 202 over a cloud 206 through a communication interface 20249. A file system maintenance controller 20241 of the file system maintenance manager 202 may determine the amount of file system maintenance work to be performed, divides the amount of file system maintenance work determined into multiple work chunks, places these work chunks in an unprocessed work chunk pool. In exemplary embodiments, the method may also include monitoring the status changes of the compute nodes available and the storage devices available in a predetermined interval. At block 404, a work chunk dispatcher 20245 of the file system maintenance manager 202 dispatches the work chunks in the unprocessed work chunk pool to the compute nodes available for performing file system maintenance.

In certain embodiments, at block 406, the system status monitor 20243 of the file system maintenance manager 202 may monitor status changes of the compute nodes available and the storage devices available. In certain embodiments, the system status monitor 20243 of the file system maintenance manager 202 may also detect processing capacity and performance of each of the compute nodes available, and classifying the compute nodes available into high speed, medium speed, and low-speed categories, by the system status monitor 20243. At block 408, the file system maintenance manager 202 may adjust the work chunks dispatched to each of the compute nodes available according to the status changes of the compute nodes available, the storage devices available, and the processing capacity and performance of each of the compute nodes available.

In certain embodiments, the method 400 also includes dispatching unprocessed work chunks from the unprocessed work chunk pool to each of the compute nodes that become available by the work chunk dispatcher 20245.

The present invention may be a computing system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for performing file system maintenance, comprising:
surveying, by a system status monitor of a file system maintenance manager, a plurality of compute nodes available, wherein the plurality of compute nodes available is in communication with the file system maintenance manager over a cloud through a communication interface;
determining, by a file system maintenance controller of the file system maintenance manager, an amount of file system maintenance work to be performed in an unprocessed work chunk pool, wherein the amount of file system maintenance work is divided into a plurality of work chunks;
dispatching, by a work chunk dispatcher of the file system maintenance manager, the plurality of work chunks to the plurality of compute nodes available for performing a file system maintenance process;
monitoring, by the system status monitor of the file system maintenance manager, status changes of the plurality of compute nodes available; and
adjusting, by the file system maintenance controller of the file system maintenance manager, the plurality of work chunks dispatched to each of the plurality of compute nodes available according to the status changes of the plurality of compute nodes available.

2. The method of claim 1, wherein monitoring the status changes of the plurality of compute nodes available further comprises:
detecting, by the system status monitor, capacity and performance of each of the plurality of compute nodes available, and classifying the plurality of the compute nodes available into high speed, medium speed, and low speed categories; and
dispatching, by the work chunk dispatcher, a plurality of unprocessed work chunks from the unprocessed work chunk pool to each of the plurality of compute nodes available dynamically, according to the capacity and performance of each of the plurality of compute nodes available.

3. The method of claim 1, wherein the file system maintenance process comprises:
monitoring a plurality of unavailable compute nodes when the file system maintenance process started; and
adding newly available compute nodes to the plurality of compute nodes available to process unprocessed workload.

4. The method of claim 1, wherein the file system maintenance is selected from the group consisting of:
restriping file system to rebalance data across a plurality of storage devices;
performing defragmentation which reduces disk fragmentation by increasing a number of free blocks available to the file system;
changing a working status of the plurality of storage devices to start; and
optimizing the file system by fully utilizing the plurality of compute nodes available, balancing work load on each of the plurality of compute nodes available.

5. The method of claim 1, wherein monitoring comprises monitoring the status changes of the plurality of compute nodes available in a predetermined interval.

6. The method of claim 5, wherein the status changes is selected from the group consisting of:
one or more compute nodes become available; and
one or more compute nodes become unavailable;

7. The method of claim 1, wherein adjusting the plurality of work chunks dispatched to each of the plurality of compute nodes available comprises:
dispatching, by the work chunk dispatcher, a plurality of unprocessed work chunks from the unprocessed work chunk pool to each of the plurality of compute nodes that become available;
determining, by checking on a corresponding log file of a log system, an amount of work chunks processed by a compute mode that becomes unavailable, and returning unprocessed work chunks dispatched to the compute mode to the unprocessed work chunk pool for each of the plurality of compute nodes that become unavailable; and
moving, by the work chunk dispatcher, a plurality of files to each of a plurality of storage devices that become available to balance work load of the plurality of storage devices available.

8. A file system maintenance manager, comprising:
a memory storing computer executable instructions for the file system maintenance manager, and
a processor for executing the computer executable instructions, the computer executable instructions comprising:
a system status monitor configured to survey a plurality of compute nodes available, and monitor status changes of the plurality of compute nodes available;
a communication interface configured to enable the file system maintenance manager to communicate with the plurality of compute nodes available over a cloud;
a file system maintenance controller configured to determine an amount of file system maintenance work to be performed, wherein the amount of file system maintenance work is divided into a plurality of work chunks placed in an unprocessed work chunk pool, and adjust the plurality of work chunks dispatched to each of the plurality of compute nodes available according to the status changes of the plurality of compute nodes available; and
a work chunk dispatcher configured to dispatch the plurality of work chunks in the unprocessed work chunk pool to the plurality of compute nodes available for performing a file system maintenance process.

9. The file system maintenance manager of claim 8, wherein the file system maintenance manager is configured to:
detect, by the system status monitor, capacity and performance of each of the plurality of compute nodes available, and classify the plurality of the compute nodes available into high speed, medium speed, and low speed categories; and
dispatch, by the work chunk dispatcher, a plurality of unprocessed work chunks from the unprocessed work chunk pool to each of the plurality of compute nodes available dynamically, according to the capacity and performance of each of the plurality of compute nodes available.

10. The file system maintenance manager of claim 8, wherein the file system maintenance process comprises:
monitoring a plurality of unavailable compute nodes when the file system maintenance process started; and adding newly available compute nodes to the plurality of compute nodes available to process unprocessed workload.

11. The file system maintenance manager of claim 8, wherein the file system maintenance comprises:
restriping file system to rebalance data across a plurality of storage devices;
performing defragmentation which reduces disk fragmentation by increasing a number of free blocks available to the file system;
changing a working status of the plurality of storage devices to start; and
optimizing the file system by fully utilizing the plurality of compute nodes available, balancing work load on each of the plurality of compute nodes available.

12. The file system maintenance manager of claim 8, wherein the file system maintenance manager is configured to monitor the status changes of the plurality of compute nodes available in a predetermined interval using the system status monitor.

13. The file system maintenance manager of claim 12, wherein the status changes is selected from the group consisting of:
one or more compute nodes become available; and
one or more compute nodes become unavailable.

14. The file system maintenance manager of claim 8, wherein the file system maintenance manager is configured to:
dispatch, using the work chunk dispatcher a plurality of unprocessed work chunks from the unprocessed work chunk pool to each of the plurality of compute nodes that become available;
determine, by checking on a corresponding log file of a log system, an amount of work chunks processed by a compute mode that becomes unavailable, and return unprocessed work chunks dispatched to the compute mode to the unprocessed work chunk pool for each of the plurality of compute nodes that become unavailable; and
move, using the work chunk dispatcher a plurality of files to each of a plurality of storage devices that become available to balance work load of the plurality of storage devices available.

15. A computer program product for performing file system maintenance, comprising a computer readable storage medium having computer executable instructions embodied therewith, when executed by a processor of a file system maintenance manager, the computer executable instructions cause the processor to:
survey, using a system status monitor of the file system maintenance manager, a plurality of compute nodes available, wherein the plurality of compute nodes available is in communication with the file system maintenance manager over a cloud through a communication interface;
determine, using a file system maintenance controller of the file system maintenance manager, an amount of file system maintenance work to be performed in an unprocessed work chunk pool, wherein the amount of file system maintenance work is divided into a plurality of work chunks;
dispatch, using a work chunk dispatcher of the file system maintenance manager, the plurality of work chunks to the plurality of compute nodes available for performing a file system maintenance process;
monitor, using the system status monitor of the file system maintenance manager, status changes of the plurality of compute nodes available; and
adjust, using the by the file system maintenance controller of the file system maintenance manager, the plurality of work chunks dispatched to each of the plurality of compute nodes available according to the status changes of the plurality of compute nodes available.

16. The computer program product of claim 15, wherein the file system maintenance manager is configured to:
detect, by the system status monitor, capacity and performance of each of the plurality of compute nodes available, and classify the plurality of the compute nodes available into high speed, medium speed, and low speed categories; and
dispatch, by the work chunk dispatcher, a plurality of unprocessed work chunks from the unprocessed work chunk pool to each of the plurality of compute nodes available dynamically, according to the capacity and performance of each of the plurality of compute nodes available.

17. The computer program product of claim 15, wherein the file system maintenance process is selected from the group consisting of:
monitoring a plurality of unavailable compute nodes when the file system maintenance process started; and adding newly available compute nodes to the plurality of compute nodes available to process unprocessed workload;
restriping file system to rebalance data across a plurality of storage devices;
performing defragmentation which reduces disk fragmentation by increasing a number of free blocks available to the file system;
changing a working status of the plurality of storage devices to start; and
optimizing the file system by fully utilizing the plurality of compute nodes available, balancing work load on each of the plurality of compute nodes available.

18. The computer program product of claim 15, wherein monitoring comprises monitoring the status changes of the plurality of compute nodes available in a predetermined interval, wherein the status changes comprise is selected from the group consisting of:
one or more compute nodes become available; and
one or more compute nodes become unavailable.

19. The computer program product of claim 18, wherein a storage device becomes unavailable when a file system daemon is terminated on a corresponding compute mode performing the file system maintenance on the storage device.

20. The computer program product of claim 15, wherein the file system maintenance manager is configured to:
dispatch, using the work chunk dispatcher a plurality of unprocessed work chunks from the unprocessed work chunk pool to each of the plurality of compute nodes that become available;
determine, by checking on a corresponding log file of a log system, an amount of work chunks processed by a compute mode that becomes unavailable, and return unprocessed work chunks dispatched to the compute mode to the unprocessed work chunk pool for each of the plurality of compute nodes that become unavailable; and
move, using the work chunk dispatcher a plurality of files to each of a plurality of storage devices that become available to balance work load of the plurality of storage devices available.
